(19) United States
(12) Patent Application Publication
(10) Pub. No.: US 2018/0218334 A1
(43) Pub. Date: Aug. 2, 2018

(54) Electronic Personal Networking System, Messaging Apparatus, and Persistent Introduction Process

(71) Applicant: Notion AI Inc., Ann Arbor, MI (US)

(72) Inventors: Lindsay Snider, Ann Arbor, MI (US); Ian Berry, Ann Arbor, MI (US); Guy Suter, Ann Arbor, MI (US)

(21) Appl. No.: 15/423,534

(22) Filed: Feb. 2, 2017

(51) Int. Cl. G06Q 10/10; H04L 12/58; G06F 17/30

(52) U.S. Cl. CPC G06Q 10/1095; G06F 17/3053; H04L 51/02; H04L 51/32

(57) ABSTRACT

An apparatus transforms a request for an introduction and a message archive into a submission to a selected intermediary for endorsement or denial. In embodiments, the submission may include time, place, manner and a gloss of her relationship of requestor to the selected intermediary. An intersection is sought among ranked correspondents of a requestor and strong influencers of a desired invitee to intermediate an introduction of requestor to invitee. A method suggests a proposed introduction message to a selected intermediary for endorsement based on measures of relationships the intermediary has derived from message archives. A method determines a relationship metric of the oldest and first introduction of one party to another. A method transforms a plurality of messages, a request, and a calendar into an exchange of proposed and endorsed introduction messages for and by a selected intermediary based on relationships inferred from the message archive.

### CROSS-REFERENCE TO RELATED APPLICATIONS

None

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

The disclosure relates to electronic messaging such as email, text, and social media. More particularly, the methods and systems described herein relate to improvements in responsiveness and quality of replies.

Conventional social media systems enable strangers to solicit “friendship” based on little more than self-promotion and lack of inhibition. Excessive politeness has deprecated the value of such informal coupling.

What is needed is a more data driven introduction process to improve probability of success. Of all possible intermediaries, one who has credibility and has been measured for better matching of credentials, taste, or personality would be more desireable.

### BRIEF SUMMARY OF INVENTION

An apparatus enables transformation of a request for an introduction and a message archive into a submission transmitted to a selected intermediary for endorsement or denial. In embodiments, the submission may include time, place, manner and a gloss of the relationship of requestor to the selected intermediary. An intersection is sought among ranked correspondents of a requestor and strong influencers of a desired invitee to intermediate an introduction of requestor to invitee.

A method suggests a proposed introduction message to a selected intermediary for endorsement based on measures of relationships the intermediary has derived from message archives. The method persists as new messages are archived and thus reveal improving or new relationships. A message archive is continually transformed into a dataset of relationship metrics. A method determines a relationship metric of the oldest and first introduction of one party to another.

A method transforms a plurality of messages, a request, and a calendar into an exchange of proposed and endorsed introduction messages for and by a selected intermediary based on relationships deduced from the message archive.

An apparatus receives and stores requests for introduction from a client. The Requestor identifies a patron she desires to be introduced to (Invitee). The apparatus has an archive (in non-transitory storage) of messages sent and received by the Requestor and messages sent and received by the Invitee. The relationships of the Requestor are measured by message volume, content, tone, frequency, recency, responsivity, and exclusivity. Similarly the relationships of the Invitee to her message senders are measured. The relationships are ranked and the intersection of the list with highest combined rank becomes the ranked list of message senders who may be requested to act as an intermediary.

As the span of relationships grows, the persistent request identifies new potential intermediaries with proven influence and success in making introductions.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIGS. 1-3 are block diagrams of systems and circuits of an apparatus embodiment of the invention;

FIGS. 4-5 are flowcharts of process steps in a method embodiment; and

FIG. 6 is a block diagram of a processor suitable for performing a method embodiment of the invention;

FIGS. 7A-D illustrate dataflows;

FIG. 8 a block diagram of a system; and

FIGS. 9-11 are method flowcharts of an exemplary method of operation.

### DETAILED DESCRIPTION OF INVENTION

A system for members of a messaging service automates introductions based at least on meta-data. Content analysis further improves the matching between parties. A non-transitory storage of message archives contains at least message meta-data from which, in an embodiment, message content could be retrieved. Message meta-data for a member includes, at least, subject, date, reply-to, sent-from, sent-to, and in an embodiment, tone. Two members of the messaging service may have nothing in common according to the stored meta data at a first point in time. A request for introduction (RFI) process searches available meta-data for all members to discover an overlap or intersection between meta-data. Overlaps include, but are not limited to, sender identities, recipient identities, and subject matter. A process determines relationship strength and ranks a potential intersection according to such factors as frequency F, recency R, bilateral balance B and exceeding at least a minimum threshold S. Measurement of relationships is known and is not reiterated for clarity of exposition. An opt-in/opt-out process first selects an intermediary meta-data (such as a message sender or recipient). An intermediary which is highly ranked on one side but not the other is less powerful than one which is more evenly appreciated by and/or values the relationship with each of the two parties. In other words, a requestor wishes an introduction to a desired patron. Within the intersection of their respective correspondents is one or more potential intermediaries. The process selects a correspondent who is relatively influential to the desired patron and seeks approval from or appreciates the requestor. If no intermediary sufficiently fulfills the requirement, the request for introduction persists, until such an indirect relationship develops.

Metrics may characterize some relationships as asymmetrical in strength or influence. Understanding and utilizing a directional asymmetry affects the ranking of intermediaries.

Another aspect of the invention is an apparatus including a message server communicatively coupled to a plurality of user-interface devices; a non-transitory store of message meta-data; a non-transitory store of relationship metrics between message senders and recipients; a processor coupled to all the stores and the message server; a non-transitory store of executable instructions which when performed by the processor: receives messages; determines message meta-data including dates, sender, recipients, tone, and reply-to; determines strength of relationship between sender and recipient; receives a request for introduction to a patron from a client; identifies a nominal intermediary; presents an opt-in/opt-out selection to the nominal intermediary; provides an editable draft introduction message; and transmits a message of introduction.

Another aspect of the invention is a method for initiation of an unmediated introduction which includes: receiving subject matter interest selection by any party; receiving at least one request from a first party for introduction to a second party containing a subject and personal précis; accessing calendars of the first party and the second party; determining that both first party and second party are traveling through the same city on overlapping days; transmitting an opt-in/opt-out solicitation to second party for a meeting with first party with proposed time/date, the subject, and requesters personal précis; and transmitting an opt-in/opt-out solicitation to any party expressing subject matter interest for a meeting with a party having said subject matter in a plurality of messages.

One aspect of the invention is a method for identifying a nominal intermediary for an introduction to a patron desired by a client including the processes: continuously writing received messages into a non-transitory store; receiving a request from a client identity for an introduction to a patron identity (RFI); determining a plurality of message senders who have a relationship with the patron identity (patron influencers); determining a plurality of message recipients who have a relationship with the client identity (client posse); ranking the strength of relationships within the list of patron influencers; ranking the strength of relationships within the list of client posse; selecting at least one intersection of the patron influencers and client posse associated with rank in strength of relationship that exceeds a minimum threshold; upon an event that changes either ranked list, reselecting another intersection; and designating said intersection as a nominal intermediary identity.

In an embodiment, an event that changes a ranked list is receipt of a message between a member of the list of patron influencers and the list of client posse.

In an embodiment, a relationship between a sender and a recipient is measured by bilateral exchange of reply-to messages above a threshold.

In an embodiment, strength of relationship is measured by frequency, recency, mood, and prompt directionality of reply-to messages.

In an embodiment, the method also includes accessing calendars of patron and client; and including a proposed time, date, and contact information for a virtual meeting or a physical meeting.

In an embodiment, the method also includes accessing calendars of intermediary, patron, and client; and including a proposed time, date, and location for a physical meeting or a virtual meeting.

Another aspect of the invention is a method for intermediating relationship based introduction messaging, for example, including the processes: determining from non-transitory message archive stores, a first nominal intermediary identity for fulfillment of a request for introduction (determining process); receiving at a server a requestor identity, a nominal intermediary identity, and a desired patron identity; transmitting to the first nominal intermediary identity, an opt-in/opt-out solicitation on behalf of the requestor identity; iterating the determination for a second nominal intermediary on the condition that an opt-in/opt-out solicitation is refused; providing draft language for adoption and customization by the intermediary; transmitting an introduction message; and tracking the fulfillment of the introduction.

In an embodiment, the method also includes recording the cooperation of each nominal intermediary; and recording the success rate of RFI fulfillment.

In an embodiment, successful and high volume intermediaries receive recognition by either tangible gifts or intangible reputation.

In an embodiment, draft language includes history of the intermediary with requestor and patron.

In an embodiment, providing draft language comprises an available time and location selected from respective calendars and travel itineraries.

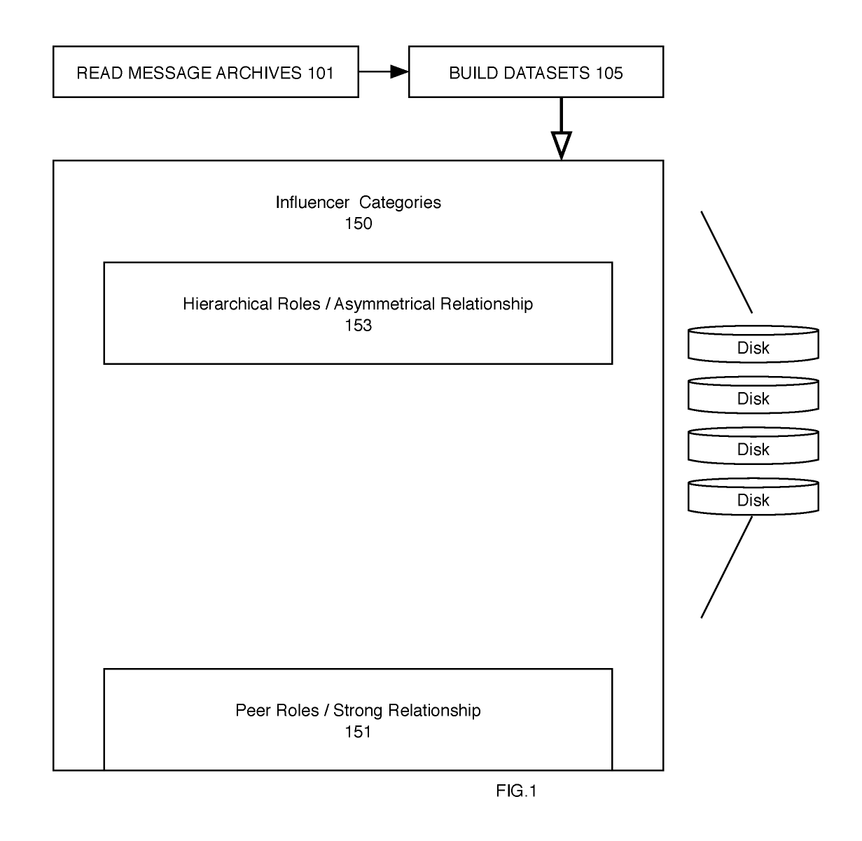

Referring now to FIG. 1, a process reads messages from at least one message archive 101; and builds a dataset 105 to measure relationships between message senders and recipients based on recency, frequency, content, and responsivity. Among influencer categories 150 are two exemplary and non-limiting measures. Based on email traffic patterns between senders and recipients, the correspondents may be recognized as behaving in peer roles but with a strong relationship 151. Another pattern may suggest the correspondents may fulfill parts in a hierarchical role with power or responsiveness consistent with an asymmetrical relationship 153.

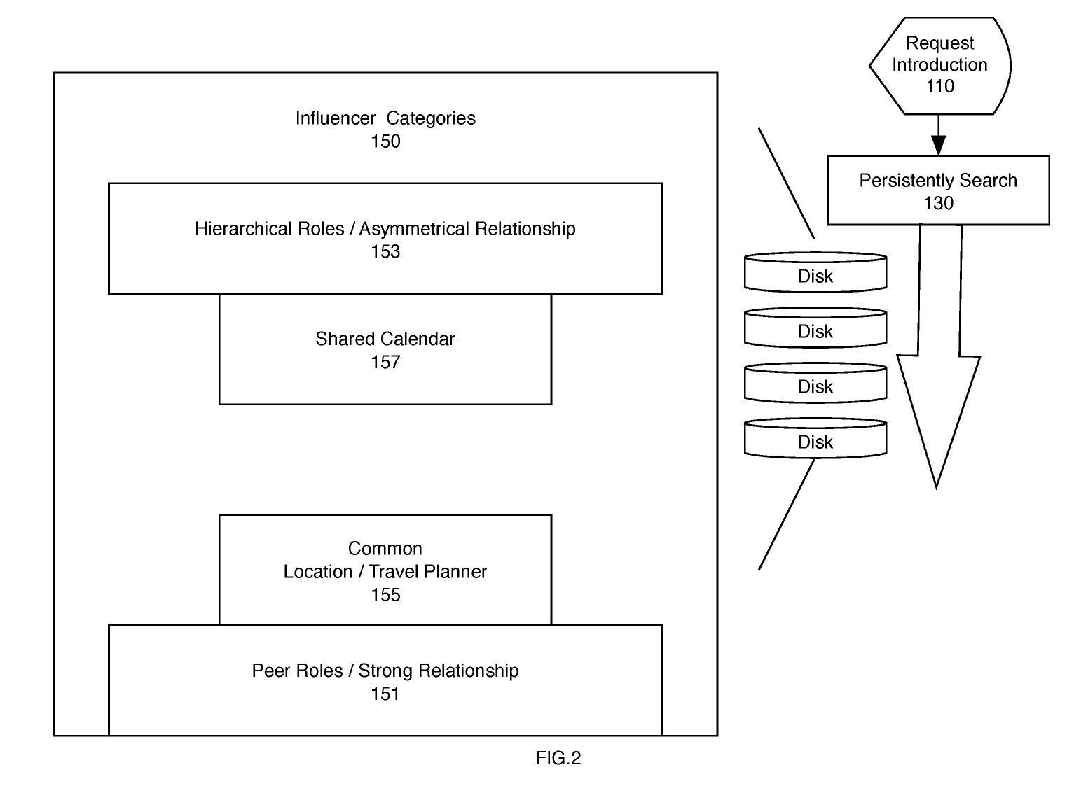

Referring now to FIG. 2, upon receiving an introduction request 110, the apparatus orders the relationships of the requestor and the relationships of the desired invitee. One example of factors which would weight the influencers in the ordering would be a message recipient who has a common location or participates in planning travel 155 or shared access to a calendar 157 as reflected in messages exchanged with requestor or invitee. There may be thresholds below which, none of the influencers have sufficiently strong relationships to trigger any progress on the request in which case the search persists and monitors changes In the dataset. One aspect of the building a dataset process is determining when the oldest and first introduction between any two individuals occurred.

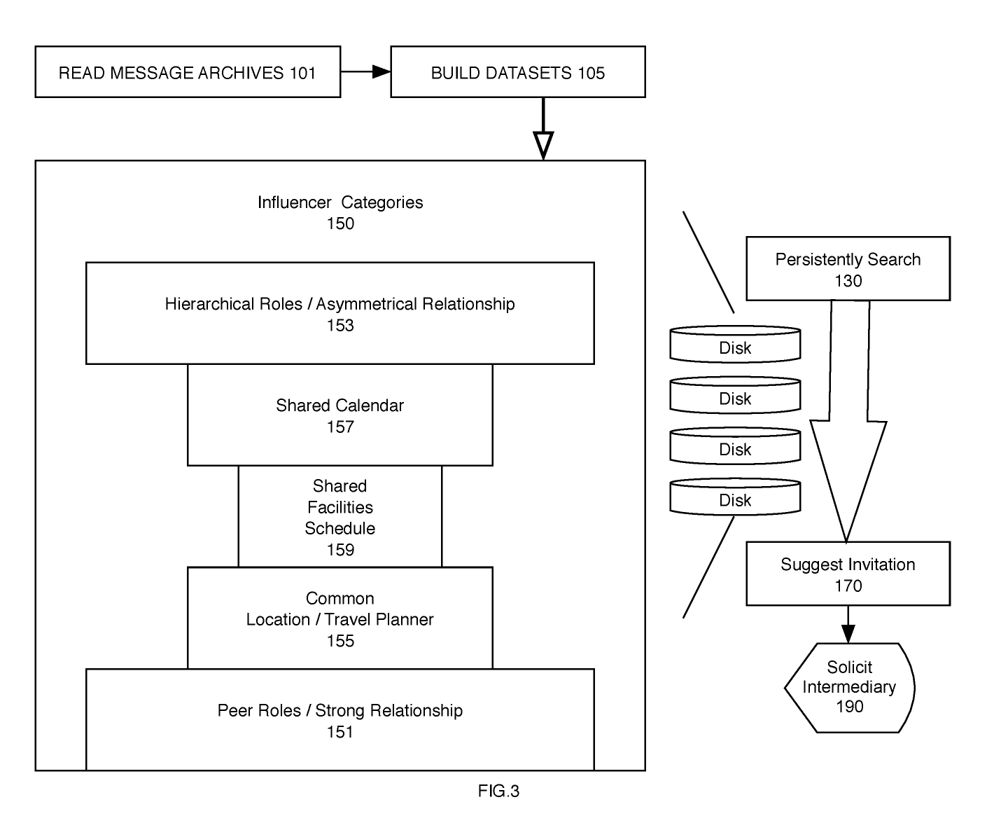

Referring now to FIG. 3, another exemplary influencer category may be that it can be determined from continuing to monitor message archives 101, that two correspondents share an ability to schedule facilities 159 such a conference room, or a suite at a trade show. Or continuing traffic shows that influence has grown or new message recipients have entered the dataset. Upon meeting a minimum threshold of relationship strength, the persistent search triggers an invitation process 170. A number of candidates may be suggested by the method as a potential intermediary so they are ranked by measure of likelihood of success. The apparatus includes means to solicit a selected intermediary 190.

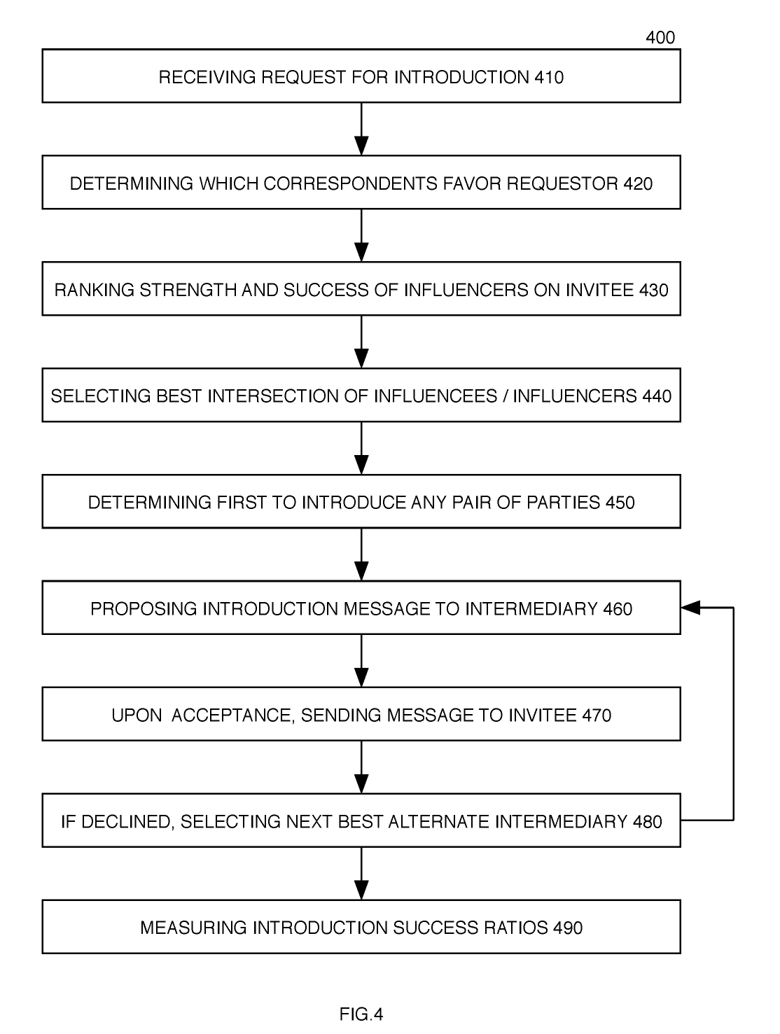

Referring now to FIG. 4, a method flowchart 400 illustrates the processes that transform a request into a meeting or introduction intermediation. The method includes: receiving from a first party (Requestor) a request for introduction (RFI) to a second party (Invitee) 410; determining, from among requestor's correspondents, which correspondents view requestor most favorably 420; ranking Invitee's correspondents by strength of relationship and success in influencing the Invitee 430; selecting best i.e. optimum intersection of ranked influencers/influences 440; determining first to successfully introduce any pair of parties from message archives 450; proposing an introduction message to a candidate intermediary, such as by suggesting time, place, manner of introduction language 460; upon acceptance or amendment by intermediary, sending the introduction message to Invitee 470; if declined, selecting next best alternate intermediary 480; and measuring success rate for introductions by each intermediary 490.

e.g. Do invitee and requestor commence substantial bilateral message traffic within a calendar window. Do introduction messages from an intermediary succeed more often than fail. Do successful introductions by an intermediary exceed a threshold or mean of all intermediaries.

A method to determine who introduced any two parties 500 using the following processes:
1. as messages come in, check to see if message is a reply to or got a reply from another message
2. if message not part of a thread, done
3. define message from and message to. message from is the message which got a reply from the other message. message to is the message which replied to the other message
4. skip introducing yourself
5. the potential person doing the introduction is the sender of the message from
6. the potential people being introduced is the sender of both the message from and the message to
7. if the message from was a reply to another message, consider replacing the replied to message as the new message from
8. if the replied to message has the potential person being introduced in the email list, switch the message from to the replied to message and go back to the last step
9. take the introduction consisting of someone introducing someone else and compare it to what we know about the person being introduced
10. a) we don't have any information about the person being introduced: record the introduction
10. b) we have knowledge of the person being introduced from an earlier date: do nothing
10. c) we have knowledge of the person being introduced from a later date: replace the known introduction

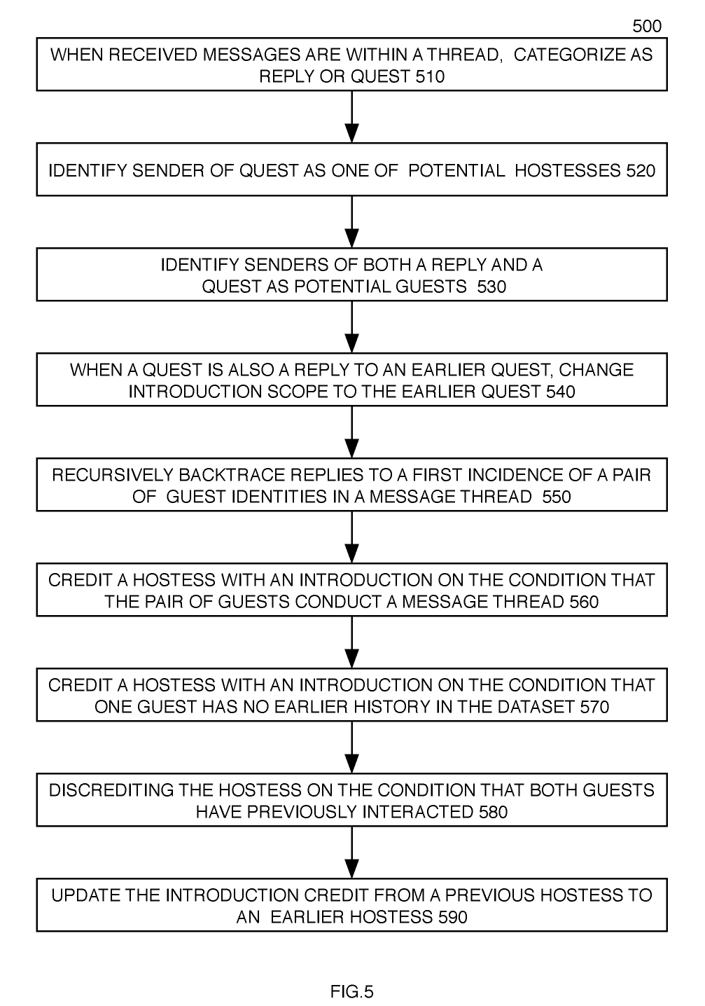

Referring now to FIG. 5, a method performed by a processor executing instructions encoded in non-transitory computer readable media causes the following data transformations: when received messages are within a thread, categorizing each message as at least one of a reply or a quest 510; identifying the sender of a quest as one of potential hostesses 520; identifying senders of both a reply and a quest as potential guests 530; when a quest is also a reply to an earlier request, changing introduction scope to the earlier quest 540; recursively backtracing replies to a first instance of a pair of guest identities in a message thread 550; crediting a hostess with an introduction only on the condition that the pair of guests conduct a subsequent message thread within a timeframe 560; crediting a hostess with an introduction on the condition that one guest has no earlier history in the data set 570; discrediting the hostess on the condition that both guests have previously interacted 580; and updating the introduction credit from a previous hostess to an earlier hostess 590.

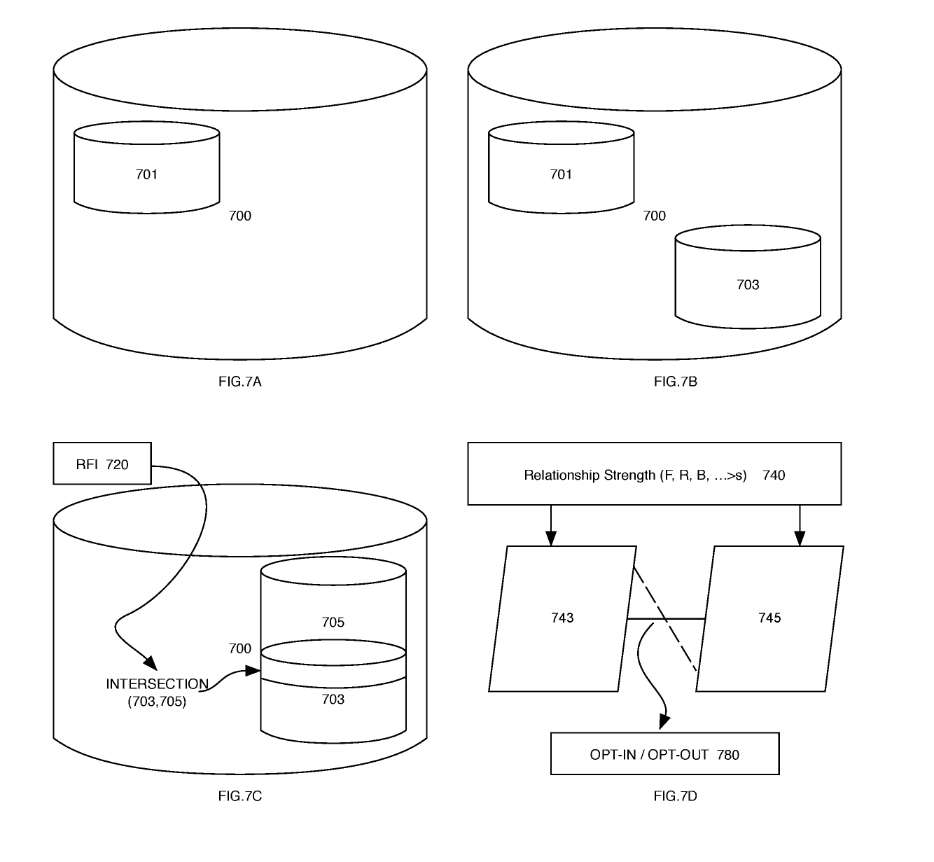

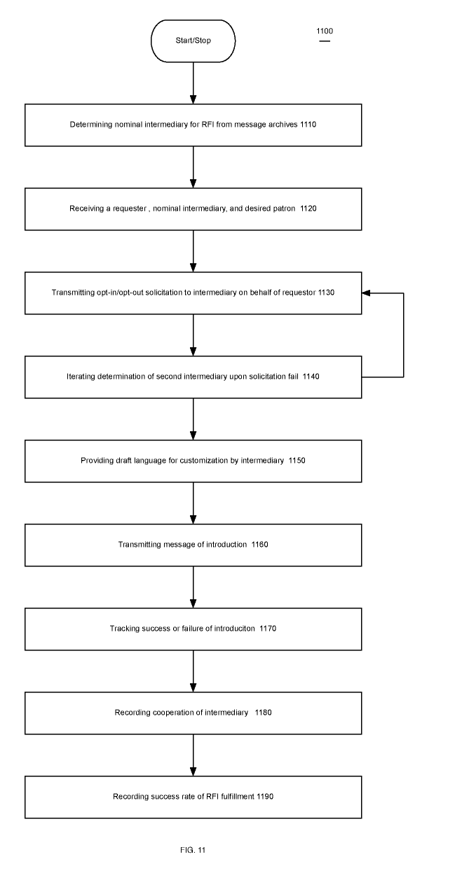

Another aspect of the invention is illustrated in FIGS. 7A-D through FIG. 11.

FIG. 7A-D shows a system for members of a messaging service which automates introductions based at least on meta-data. Content analysis further improves the matching between parties. Referring to FIG. 7A, a non-transitory store contains at least message meta-data 700 from which in an embodiment, message content could be retrieved. Message meta-data for a member 701 includes at least, subject, date, reply-to, sent-from, sent-to, and in an embodiment, tone.

Referring to FIG. 7B, two members of the messaging service may have nothing in common according to the stored meta data at a point in time 701, 703.

Referring to FIG. 7C, a request for introduction (RFI) 720 process searches available meta-data for all members to discover an overlap or intersection between meta-data 703 and 705. Overlaps include but are not limited to sender identities, recipient identities, and subject matter.

Referring to FIG. 7D, a process 740 determines relationship strengths 743 745 and ranks a potential intersection according to such factors as frequency F, recency R, bilateral balance B and exceeding at least a minimum threshold S. An opt-in/opt-out process 780 first selects an intermediary meta-data (such as a message sender or recipient). An intermediary which is highly ranked on one side but not the other is less powerful than one which is more evenly appreciated by and/or values the relationship with the two parties.

In other words, a requestor wishes an introduction to a desired patron. Within the intersection of their respective correspondents is one or more potential intermediaries. The process selects a correspondent which is relatively influential to the desired patron and seeks approval from or appreciates the requestor. If no intermediary fulfills the requirement, the request for introduction persists, until such an indirect relationship develops.

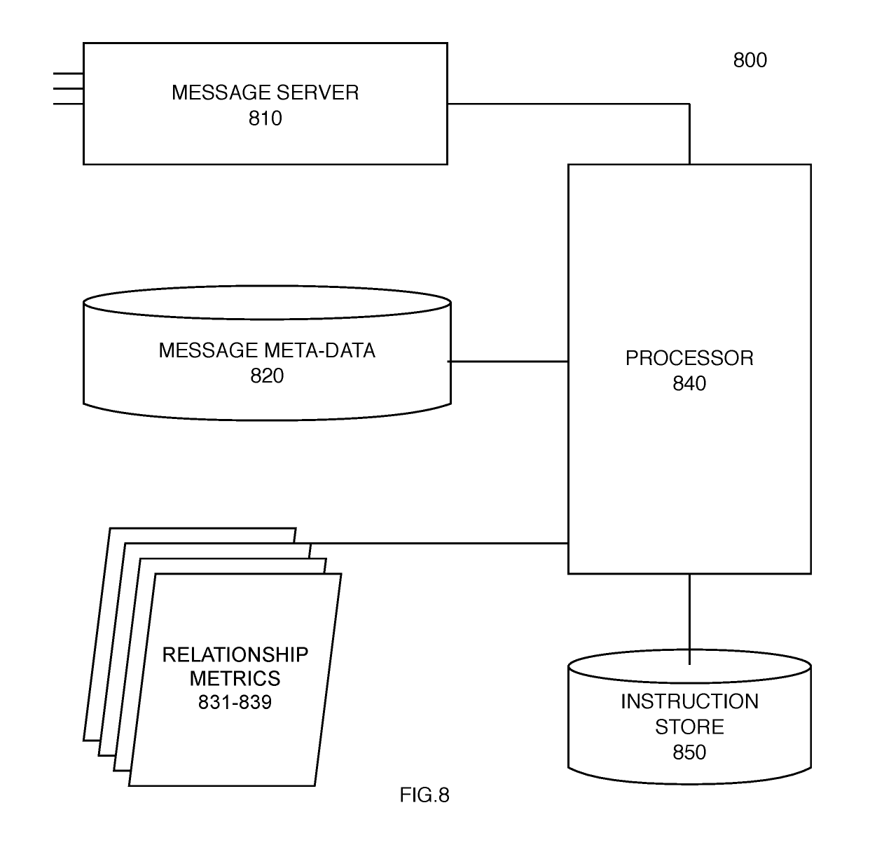

Another aspect of the invention is an apparatus 800 as shown in FIG. 8 including a message server communicatively coupled to a plurality of user-interface devices 810; a non-transitory store of message meta-data 820; a non-transitory store of relationship metrics between message senders and recipients 831-839; a processor coupled to all the stores and the message server 840; a non-transitory store 850 of executable instructions which when performed by the processor: receives messages; determines message meta-data including dates, sender, recipients, tone, and reply-to; determines strength of relationship between sender and recipient; receives a request for introduction to a patron from a client; identifies a nominal intermediary; presents an opt-in/opt-out selection to the nominal intermediary; provides an editable draft introduction message; and transmits a message of introduction.

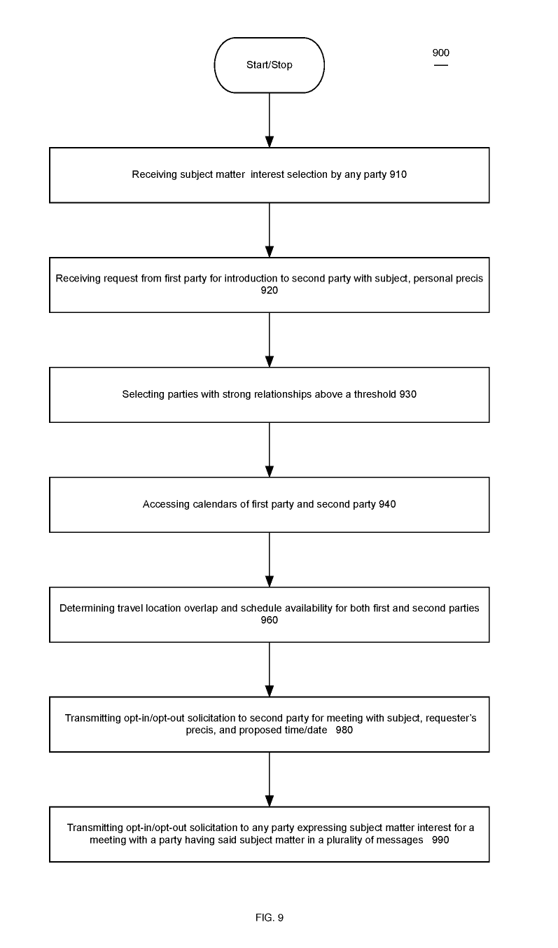

Another aspect of the invention is a method 900 for initiation of an unmediated introduction illustrated in FIG. 9 which includes: receiving subject matter interest selection by any party 910; receiving at least one request from a first party for introduction to a second party containing a subject and personal précis 920; selecting parties in the dataset with relationship strengths related to this subject matter above a threshold 930; accessing calendars of the first party and the second party 940; determining that both first party and second party are traveling through the same city on overlapping days 960; transmitting an opt-in/opt-out solicitation to second party for a meeting with first party with proposed time/date, the subject, and requesters personal précis 980: and transmitting an opt-in/opt-out solicitation to any party expressing subject matter interest for a meeting with a party having said subject matter in a plurality of messages 990.

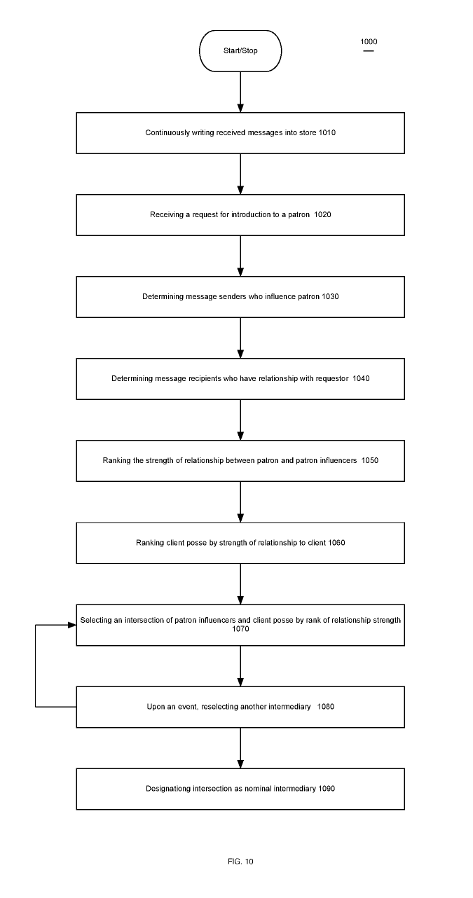

One aspect of the invention is a method for identifying a nominal intermediary for an introduction to a patron desired by a client shown in FIG. 10 including the processes: continuously writing received messages into a non-transitory store 1010; receiving a request from a client identity for an introduction to a patron identity (RFI) 1020; determining a plurality of message senders who have a relationship with the patron identity (patron influencers) 1030; determining a plurality of message recipients who have a relationship with the client identity (client posse) 1040; ranking the strength of relationships within the list of patron influencers 1050; ranking the strength of relationships within the list of client posse 1060; selecting at least one intersection of the patron influencers and client posse associated with rank in strength of relationship that exceeds a minimum threshold 1070; upon an event that changes either ranked list, reselecting another intersection 1080; and designating said intersection as a nominal intermediary identity 1090.

In an embodiment, an event that changes a ranked list is receipt of a message between a member of the list of patron influencers and the list of client posse.

In an embodiment, a relationship between a sender and a recipient is determined by bilateral exchange of reply-to messages above a threshold.

In an embodiment, strength of relationship is measured by frequency, recency, mood, and prompt directionality of reply-to messages.

In an embodiment, the message meta data, the strengths of relationships, and the ranked potential intermediaries is encrypted and written to a secure non-public non-transitory media. The nature of the relationships and the metrics are stored in a way to ensure the privacy of every party.

Referring now to FIG. 11, one aspect of the invention is a method 1100 for intermediating relationship based introduction messaging, the method including the processes: determining from non-transitory message archive stores, a first nominal intermediary identity for fulfillment of a request for introduction (determining process) 1110; receiving at a server a requestor identity, a nominal intermediary identity, and a desired patron identity 1120; transmitting to the first nominal intermediary identity, an opt-in/opt-out solicitation on behalf of the requestor identity 1130; iterating the determination for a second nominal intermediary on the condition that an opt-in/opt-out solicitation is refused 1140; providing draft language for adoption and customization by the intermediary 1150; transmitting an introduction message 1160; and tracking the fulfillment of the introduction 1170.

In an embodiment, the method also includes recording the cooperation of each nominal intermediary 1180; and recording the success rate of RFI fulfillment 1190.

In an embodiment, draft language includes history of the intermediary with requestor and patron.

In an embodiment, providing draft language comprises an available time and location selected from respective calendars and travel itineraries.

As is known, circuits disclosed above may be embodied by programmable logic, field programmable gate arrays, mask programmable gate arrays, standard cells, and computing devices limited by methods stored as instructions in non-transitory media.

Generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, HTML5, or any other type and/or form of executable instructions capable of executing on a computing device.

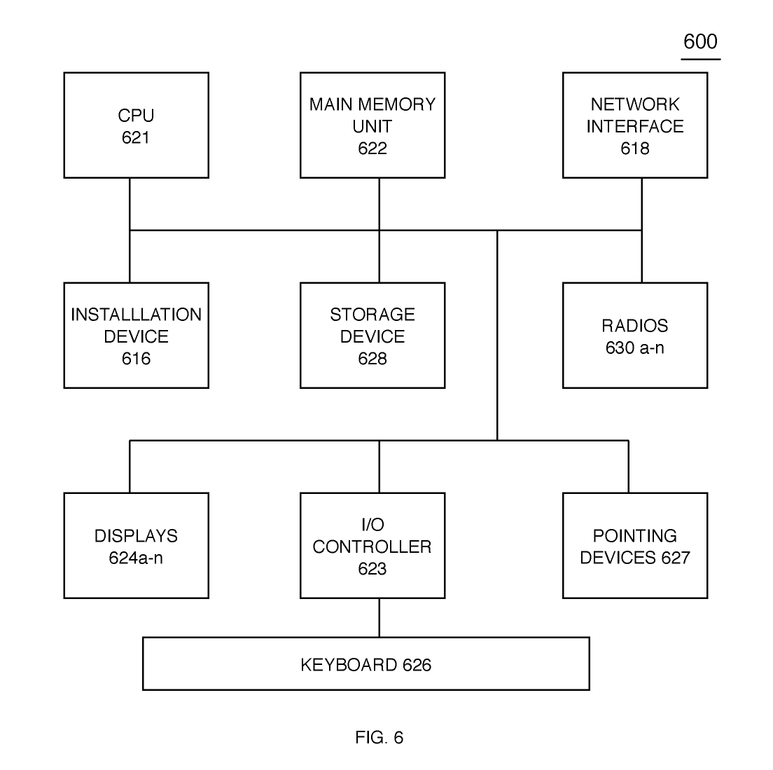

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by TSMC; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips.

Furthermore, the computing device 600 may include a network interface 618 to interface to a network through a variety of connections including, but not limited to, standard telephone lines, LAN or WAN links, broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; and Huawei Technologies Co. Ltd. Of Shenzhen, Guangdong China. In yet other embodiments, the computing device 600 is a smart phone, Pocket PC Phone, or other portable mobile device.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

In an embodiment, at least one message reception circuit includes: a circuit to determine a message sender, message body, and message meta-data; and a circuit to determine when a received message has a reference message.

It should be understood that the systems described above may provide multiple ones of any or each of those components and these components may be provided on either a standalone machine or, in some embodiments, on multiple machines in a distributed system. The phrases in one embodiment′, in another embodiment′, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

### CONCLUSION

The present invention can be easily distinguished from conventional personally networking apparatus and methods by the additional step of external triggering. This may be a confluence of subject matter interest and itinerary, or an intermediary who is known and respected by both parties. The apparatus has stored meta-data of the messages, stored relationship metrics of the senders and recipients of messages, and transmits an introductory message only on certain conditions: similarity of subject matter interest, propinquity of travel and schedule, intermediation of a person with strong relationships to both potential correspondents. The apparatus transforms non-transitory stored message meta-data into and transmits a message of introduction responsive to a request.

It will now become apparent to one of skill in the art that other embodiments incorporating the concepts of the disclosure may be used. Therefore, the disclosure should not be limited to certain embodiments, but rather should be limited only by the spirit and scope of the following claims.

1. A method for intermediating relationship based introduction messaging, the method comprising:
determining from non-transitory message archive stores, a first nominal intermediary identity for fulfillment of a request for introduction (determining process);
receiving at a server a requestor identity, a nominal intermediary identity, and a desired patron identity;
transmitting to the first nominal intermediary identity, an opt-in/opt-out solicitation on behalf of the requestor identity;
iterating the determination for a second nominal intermediary on the condition that an opt-in/opt-out solicitation is refused;
providing draft language for adoption and customization by the intermediary;
transmitting an introduction message; and
tracking the fulfillment of the introduction.

2. The method of claim 1 further comprising:
recording the cooperation of each nominal intermediary; and
recording the success rate of RFI fulfillment.

3. The method of claim 2 further comprising:
offering a recognition award to a nominal intermediary for participation; and
upon attaining a level of success in introductions, presenting the recognition award to the intermediary.

4. The method of claim 1 wherein draft language includes history of the intermediary with requestor and patron.

5. The method of claim 1 wherein providing draft language comprises an available time and location selected from respective calendars and itineraries.

6. The method of claim 1 wherein said determining process comprises:
continuously writing received messages into a non-transitory store;
receiving a request from a client identity for an introduction to a patron identity (RFI);
determining a plurality of message senders who have a relationship with the patron identity (patron influencers);
determining a plurality of message recipients who have a relationship with the client identity (client posse);
ranking the strength of relationships within the list of patron influencers;
ranking the strength of relationships within the list of client posse;
selecting at least one intersection of the patron influencers and client posse associated with rank in strength of relationship that exceeds a minimum threshold;
upon an event that changes either ranked list, reselecting another intersection; and
designating said intersection as a nominal intermediary identity.

7. The method of claim 6 wherein:
an event that changes a ranked list is receipt of a message between a member of the list of patron influencers and the list of client posse.

8. The method of claim 6 wherein:
a relationship between a sender and a recipient is measured by bilateral exchange of reply-to messages above a threshold.

9. The method of claim 6 wherein:
strength of relationship is measured by frequency, recency, mood, and prompt directionality of reply-to messages.

10. The method of claim 6 further comprising:
accessing calendars of patron and client; and
including a proposed time, date, and contact information for a virtual meeting.

11. The method of claim 10 further comprising:
accessing calendars of intermediary, patron, and client; and
including a proposed time, date, and location for a physical meeting.

12. A system and apparatus comprising:
a message server communicatively coupled to a plurality of user-interface devices;
a non-transitory store of message meta-data;
a non-transitory store of relationship metrics between message senders and recipients;
a processor;
a non-transitory store of executable instructions which when performed by the processor: receives messages; determines message meta-data including dates, sender, recipients, tone, and reply-to; determines strength of relationship between sender and recipient; receives a request for introduction to a patron from a client; identifies a nominal intermediary; presents an opt-in/opt-out selection to the nominal intermediary; provides an editable draft introduction message; and transmits a message of introduction.

13. A method performed by a processor on a message system to transform a request into a meeting or introduction intermediation, the method comprising:
receiving from a first party (Requestor) a request for introduction (RFI) to a second party (Invitee);
determining from requestor's correspondents which view requestor most favorably;
ranking Invitee's correspondents by strength of relationship and success in influencing the Invitee;
selecting best i.e. optimum intersection of ranked influencers/influences as a hostess;
determining first hostess to successfully introduce any pair of parties from message archives;
proposing introduction message to a candidate intermediary, such as by suggesting time, place, manner of introduction language;
upon acceptance or amendment by intermediary, sending the introduction message to Invitee;
if declined, selecting next best alternate intermediary; and
measuring success rate for introductions by each intermediary.

14. The method of claim 13 wherein determining first hostess to successfully introduce any pair of guests comprises the processes, performed by a processor on a non-transitory storage message archive:
when received messages are within a thread, categorizing each message as at least one of a reply or a quest;
identifying the sender of a quest as one of potential hostesses;
identifying senders of both a reply and a quest as potential guests;
when a quest is also a reply to an earlier request, changing introduction scope to the earlier quest;
recursively backtracing replies to a first instance of a pair of guest identities in a message thread;
crediting a hostess with an introduction only on the condition that the pair of guests conduct a subsequent message thread within a timeframe;
crediting a hostess with an introduction on the condition that one guest has no earlier history in the data set;
discrediting the hostess on the condition that both guests have previously interacted; and
updating the introduction credit from a previous hostess to an earlier hostess.
